(19) United States
(12) Patent Application Publication
(10) Pub. No.: US 2015/0254518 A1
(43) Pub. Date: Sep. 10, 2015

(54) TEXT RECOGNITION THROUGH IMAGES AND VIDEO

(71) Applicant: BLACKBERRY LIMITED, Waterloo (CA)

(72) Inventors: Jason Tyler Griffin, Kitchener (CA); Alistair Robert Hamilton, Sammimish, WA (US)

(21) Appl. No.: 14/438,347

(22) PCT Filed: Oct. 26, 2012
(86) PCT No.: PCT/US2012/062061

§ 371 Date: Apr. 24, 2015

(51) Int. Cl. G06K 9/18; G06K 9/32; G06F 17/27; G06K 9/22; G06F 17/21; G06F 17/24

(52) U.S. Cl. CPC G06K 9/18; G06F 17/21; G06F 17/24; G06F 17/2765; G06F 17/211; G06K 9/228; G06K 9/325

(57) ABSTRACT

The display of text by a first device, that is extracted and used by a second communication device, based upon a determined context of the text, is provided. The image displayed for the first device is captured by an image capture element of a second communication device, which also has a recognition module and an extraction module. The image includes the text and a context element representing a context of the text.

### BACKGROUND

Users of electronic communication devices, including mobile or wireless devices such as smart phones, mobile phones, tablets and personal digital assistants or PDAs, have access to a number of convenient and useful applications installed on their electronic communication devices. Email, calendar, Web browser, text, task, social media, contacts, and Internet search applications are some examples.

It can often be a challenge sending both data and data context across different application and computing platforms. Even within a platform, it can be difficult to share data across applications based on complicated user interfaces and the incompatibility of formats that often arises.

### BRIEF DESCRIPTION OF THE DRAWINGS

Example embodiments of the present disclosure will be described below with reference to the included drawings such that like reference numerals refer to like elements and in which:

FIG. 1 is a block diagram of a communications system that includes a server, a communications network, and various communication devices, in accordance with various example embodiments of the present disclosure;

FIG. 2 is a detailed block diagram of a mobile communication device, in accordance with various example embodiments of the present disclosure;

FIG. 3 illustrates an example user interface of a communication device, in accordance with various example embodiments of the present disclosure;

FIG. 4 illustrates a rear view of a hand-held communication device incorporating a camera in a manner consistent with certain example embodiments

FIG. 5 is an example block diagram of a hand held device consistent with certain example embodiments presented herein;

FIG. 6 illustrates applications that may be stored in a memory of a communication device, in accordance with various example embodiments of the present disclosure;

FIGS. 7-9 illustrate examples concerning various application types in accordance with various example embodiments of the present disclosure; and

FIG. 10 is a flow illustrative of an example method in accordance with methods consistent with the present disclosure.

### DETAILED DESCRIPTION

The various examples presented herein outline methods, user interfaces, and electronic devices and associated servers that provide a user with valuable information about holidays and other events occurring at a location associated with a calendar even to be taken into consideration when planning such an event.

For simplicity and clarity of illustration, reference numerals may in some instances be repeated among the figures to indicate corresponding or analogous elements. Numerous details are set forth to provide an understanding of the example embodiments described herein. The example embodiments may be practiced without these details. In other instances, well-known methods, procedures, and components have not been described in detail to avoid obscuring the example embodiments described. The description is not to be considered as limiting on the scope of the example embodiments described herein.

The terms “a” or “an”, as used herein, are defined as one or more than one. The term “plurality”, as used herein, is defined as two or more than two. The terms “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or “application” or “app” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system. The term “processor”, “controller”, “CPU”, “Computer” and the like as used herein encompasses both hard programmed, special purpose, general purpose and programmable devices and may encompass a plurality of such devices or a single device in either a distributed or centralized configuration without limitation.

Reference throughout this document to “one embodiment”, “certain embodiments”, “an embodiment”, “an implementation”, “an example” or similar terms means that a particular feature, structure, or characteristic described in connection with the embodiment, example or implementation is included in at least one example embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more example embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with certain example embodiments of the present disclosure, text that is displayed by a first device is recognized, extracted and used by a second communication device, wherein the use of the text by the second communication device is based upon a determined context of the text displayed by the first device. An image displayed by the first device is captured by an image capture element of a second communication device, which also has a recognition module and an extraction module. The image includes a context element representing a context of the text in the image.

A method consistent with certain example implementations includes a communication device analyzing an image displayed by a first device to recognize a context element associated with text of the image, the context element representing a context of the text; the communication device performing optical character recognition on the text with which the context element is associated, to generate recognized text from the text; the communication device extracting the recognized text from the image; and an application of the communication device utilizing the recognized text in accordance with the context.

A communication device, which may in certain example embodiments be a wireless mobile device, has an image capture module operable to capture an image displayed by a first device responsive to an image capture command received by the communication device; a recognition module operable to analyze the captured image to recognize a context element present in the image, the context element representing a context of the text, and to perform optical character recognition of the text; an extraction module operable to extract from the image the recognized text; and an application operable to execute on the communication device and use the recognized text in accordance with the context of the text.

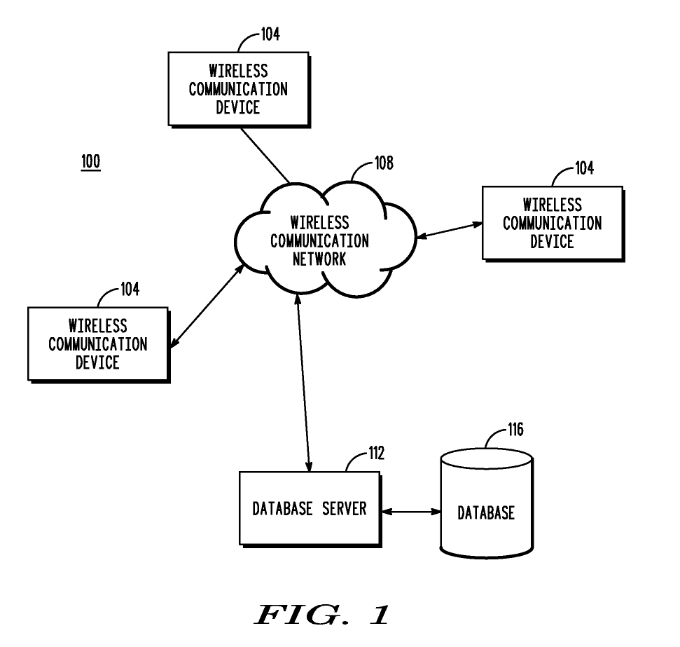

Referring now to FIG. 1, a block diagram of a distributed communications system 100 includes wireless mobile devices 104 that communicates with each other, and may also communicate with wired devices, via a communications network 108 that may integrate a number of communication networks such as the World Wide Web or Internet and wireless communication networks such as cellular communication networks. A database server 112 is also connected to the communication network 108 and may reside on the World Wide Web. It is understood that the server 112 and wireless mobile communication devices 104 may be coupled together by various types of networks, such as local area networks (LANs), cellular telephone data networks, other wide area networks (WANs) and regional networks accessed over telephone lines, such as commercial information services.

Database server 112 may include a processor, communication interfaces, memory, etc. along with a database 116. The database server 112 is able to communicate with the communications network 108 to permit the database server to retrieve and store information and data into database 116 from various resources, and may permit manual entry of such data mined from known resources. Resources can include government and private web sites, service provider resources, corporate enterprise servers, as well as other resources that are given access to directly upload events to the database 116.

Hence, in certain implementations consistent with the present disclosure, the database can be realized as a unified multisource database 116. Equipment manufacturers and service providers can implement databases or resources as a part of the services provided to customers. Companies with enterprise services such as the Blackberry Enterprise Services (BES) used by Research In Motion Limited, Ontario, Canada could have their own database in addition. Service providers, corporate web services, government entities, or other providers could also provide applications that make use of the information stored in such database. Large-scale aggregation of the data stored in the database may be useful. In an example embodiment, a single provider can act as a centralized resource of the data used by a particular user and can aggregate relevant information and data from multiple sources to make them accessible to their users.

Communication device 104 is a two-way electronic communication device having at least data and possibly also voice communication capabilities, and the capability to communicate with other communication devices or computer systems, for example, via the Internet. A communication device 104 may further be a mobile or handheld electronic device. Depending on the functionality provided by the electronic communication device, in the various example embodiments described herein, the device 104 may be a data communication device, a multiple-mode communication device configured for both data and voice communication, a smart phone, a mobile telephone or a personal digital assistant PDA (personal digital assistant) enabled for wireless communication, or a computer system with a wireless modem. Other examples of mobile electronic devices include mobile, or handheld, wireless communication devices such as pagers, cellular phones, cellular smart-phones, wireless organizers, wirelessly enabled notebook computers, tablets and so forth.

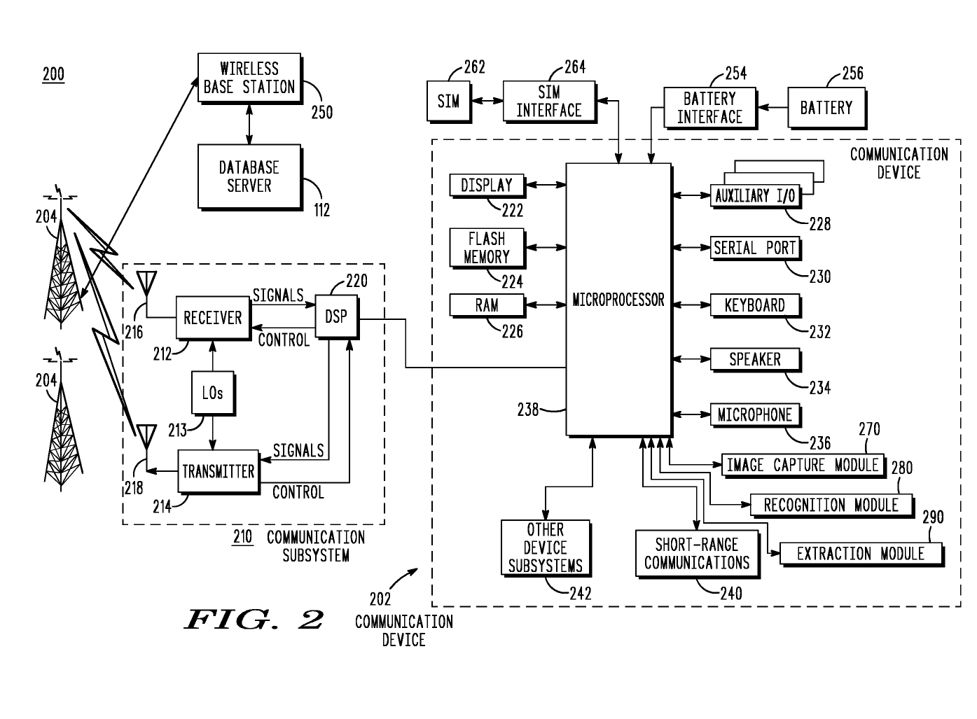

To illustrate an example of a system architecture, FIG. 2 shows a block diagram of a wireless communication system 200 which includes an electronic communication device 202, such as a wireless or mobile communication device 104, which communicates through a wireless communication network and ultimately to a base station 250 which is in communication with a database server 112, as previously discussed in FIG. 1. Mobile communication device 202 may be a two-way communication device having at least voice and advanced data communication capabilities, including the capability to communicate with other computer systems. Depending on the functionality provided by mobile communication device 202, it may be referred to as a data messaging device, a two-way pager, a cellular telephone with data messaging capabilities, a smart phone, a wireless Internet appliance, or a data communication device (with or without telephony capabilities). Mobile communication device 202 may communicate with any one of a plurality of fixed transceiver stations 204 within its geographic coverage area.

Mobile communication device 202 will normally incorporate a communication subsystem 210, which includes a receiver 212, a transmitter 214, and associated components, such as one or more (which may be embedded or internal) antenna elements 216 and 218, local oscillators (LOs) 213, and a processing module such as a digital signal processor (DSP) 220. As will be apparent to those skilled in field of communications upon consideration of the present teachings, the particular design of communication subsystem 210 depends on the communication network in which mobile communication device 202 is intended to operate.

Mobile communication device 202 may send and receive communication signals over the network after required network registration or activation procedures have been completed. Signals received by antenna 216 through the network are input to receiver 212, which may perform such common receiver functions as signal amplification, frequency down conversion, filtering, channel selection, analog-to-digital (A/D) conversion and the like. A/D conversion of a received signal allows more complex communication functions such as demodulation and decoding to be performed in DSP 220. In a similar manner, signals to be transmitted are processed, including modulation and encoding, for example, by DSP 220. These DSP-processed signals are input to transmitter 214 for digital-to-analog (D/A) conversion, frequency up conversion, filtering, amplification and transmission over communication network via antenna 218. DSP 220 not only processes communication signals, but also provides for receiver and transmitter control. For example, the gains applied to communication signals in receiver 212 and transmitter 214 may be adaptively controlled through automatic gain control algorithms implemented in DSP 220.

Network access is associated with a subscriber or user of mobile communication device 202, and therefore mobile communication device 202 may use a Subscriber Identity Module or “SIM” card 262 to be inserted in a SIM interface 264 in order to operate in the network in a known manner. Example mobile communication device 202 is a battery-powered device so it also includes a battery interface 254 for receiving one or more rechargeable batteries 256. Such a battery 256 provides electrical power to most if not all electrical circuitry in mobile communication device 202, and battery interface 254 provides for a mechanical and electrical connection for it. The battery interface 254 is coupled to a regulator (not shown) which provides a regulated voltage V to all of the circuitry.

Mobile communication device 202 includes a microprocessor 238 which controls overall operation of mobile communication device 202. Communication functions, including at least data and voice communications, are performed through communication subsystem 210. The communication techniques of the present disclosure may generally be controlled by microprocessor 238 in connection with DSP 220. Microprocessor 238 also interacts with additional device subsystems such as a display 222, a flash memory 224, a random access memory (RAM) 226, auxiliary input/output (I/O) subsystems 228, a serial port 230, a keyboard 232, a speaker 234, a microphone 236, a short-range communications subsystem 240, and any other device subsystems generally designated at 242. Some of the subsystems perform communication-related functions, whereas other subsystems may provide “resident” or on-device functions. Notably, some subsystems, such as keyboard 232 and display 222, for example, may be used for both communication-related functions, such as entering a text message for transmission over a communication network, and device-resident functions such as a calculator or task list. Operating system software used by microprocessor 238 may be stored in a persistent store such as flash memory 224, which may alternatively be a read-only memory (ROM) or similar storage element (not shown). Those skilled in the art will appreciate upon consideration of the present teachings that the operating system, specific device applications, or parts thereof, may be temporarily loaded into a volatile store such as RAM 226.

Microprocessor 238, in addition to its operating system functions, enables execution of software applications on mobile communication device 202. A set of applications which control basic device operations, including at least data and voice communication applications, will normally be installed on mobile communication device 202 during its manufacture. An application that may be loaded onto mobile communication device 202 may be a personal information manager (PIM) application having the ability to organize and manage data items relating to user such as, but not limited to, e-mail, calendar events (as will be described later), voice mails, appointments, and task items. Generally speaking, the calendar function discussed herein is carried using the calendar portion of the PIM application.

One or more memory stores are available on mobile communication device 202 and SIM 256 to facilitate storage of PIM data items and other information. The PIM application has the ability to send and receive data items via the wireless network. In the present disclosure, PIM data items are seamlessly integrated, synchronized, and updated via the wireless network, with the mobile device user's corresponding data items stored or associated with a host computer system thereby creating a mirrored host computer on mobile communication device 202 with respect to such items. This is especially advantageous where the host computer system is the mobile communication device user's office computer system. Additional applications may also be loaded onto mobile communication device 202 through network, an auxiliary I/O subsystem 228, serial port 230, short-range communications subsystem 240, or any other suitable subsystem 242, and installed by a user in RAM 226 or a non-volatile store (not shown) for execution by microprocessor 238. Such flexibility in application installation increases the functionality of mobile communication device 202 and may provide enhanced on-device functions, communication-related functions, or both. For example, secure communication applications may enable electronic commerce functions and other such financial transactions to be performed using mobile communication device 202.

In a data communication mode, a received signal such as a text message, an e-mail message, or web page download will be processed by communication subsystem 210 and input to microprocessor 238. Microprocessor 238 will further process the signal for output to display 222 or alternatively to auxiliary I/O device 228. A user of mobile communication device 202 may also compose data items, such as e-mail messages and calendar events, for example, using-keyboard 232 in conjunction with display 222 and possibly auxiliary I/O device 228. Keyboard 232 may be a complete alphanumeric keyboard or telephone-type keypad. These composed items may be transmitted over a communication network through communication subsystem 210. For voice communications, the overall operation of mobile communication device 202 is substantially similar, except that the received signals would be output to speaker 234 and signals for transmission would be generated by microphone 236. Alternative voice or audio I/O subsystems, such as a voice message recording subsystem, may also be implemented on mobile communication device 202. Although voice or audio signal output may be accomplished primarily through speaker 234, display 222 may also be used to provide an indication of the identity of a calling party, duration of a voice call, or other voice call related information, as some examples.

Serial port 230 in FIG. 2 may be implemented in a personal digital assistant (PDA)-type communication device for which synchronization with a user's desktop computer is a useful, albeit optional, component. Serial port 230 enables a user to set preferences through an external device or software application and extends the capabilities of mobile communication device 202 by providing for information or software downloads to mobile communication device 202 other than through a wireless communication network. The alternate download path may, for example, be used to load an encryption key onto mobile communication device 202 through a direct and thus reliable and trusted connection to thereby provide secure device communication. Short-range communications subsystem 240 of FIG. 2 is an additional component which provides for communication between mobile communication device 202 and different systems or devices, which need not necessarily be similar devices.

In FIG. 2, the impact event database server is shown to be in communication with the wireless base station 250. In this example, the impact event database server 112 is accessed using, for example, 3G or 4G data communication provided by a wireless telephone system. However, this should not be considered limiting since the device 202 could also access the impact event database server via any suitable wired or wireless communication protocol including short range communications 240, serial port 230 or other communication interface connections such as universal serial port (USB), wired or wireless Ethernet or other connections provided to the device 202.

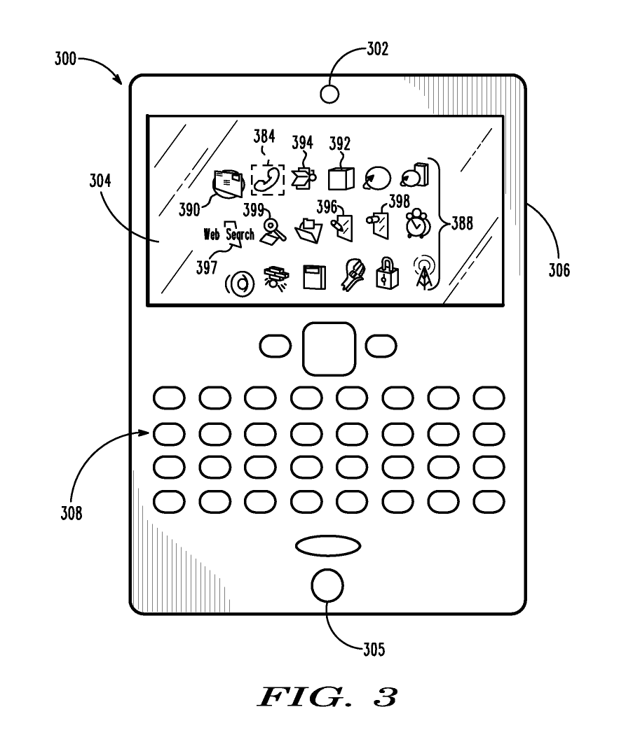

In accordance with various example embodiments described herein, the text that is displayed by a first device is extracted and used by a second communication device, wherein the use of the text by the second communication device is based upon a determined context of the text displayed by the first device. The image displayed for the first device is captured by an image capture element 270 of a second communication device, which also has a recognition module 280 and an extraction module 290. The image includes the text and a context element representing a context of the text. Image capture element 270, recognition module 280 and an extraction module 290 are all in communication and controlled by processor 238. As will be discussed, the image capture element 270 may be a video camera or phone, for example, of an electronic device, such as optical capture unit 314 of FIG. 3. Recognition module 280 is configured to analyze an image displayed by the first device to recognize from the image, text and a context element representing a context of the text. Recognition module 280 is also configured to perform optical character recognition on the text to generate recognized text from the text. Extraction module 290 extracts the recognized text from the image. An application on the second communication device can utilize the recognized text in accordance with the context.

JASON, PLEASE REVIEW THIS DEFINITION: Context elements provide cues to the system about the context of what is being captured and what elements of the data are relevant. Thus it can be seen that context, as used herein, can be defined as aspects, surrounding the recognized text or within the recognized text, which describe or indicate the environment or setting in which the recognized text is used. These aspects will be referred to herein as context elements. Context elements can be, for example, formatting, keywords, names, geographical information, display layouts, patterns, or other elements surrounding the recognized text or within the recognized text. Using the recognized text and the context elements, the second communication device can determine a context of the recognized text and an application use of the recognized text.

For example, recognition module 280 may recognize the text “reschedule the meeting for Nov. 2, 2012” from an image captured from a first device, and determine that the word “reschedule” and phrase “Nov. 2, 2012” are context elements. (The recognition module 280 may include a database of context elements. including keywords, names, geographical information, phrase formats and character string formats, with which it compares words, phrases and/or character strings of the recognized text. The database may also include formatting, display layouts, patterns or other elements associated with different applications and/or software platforms, such as for example, display layouts of certain calendar, address book and messaging applications.) The application on the second device can use the context elements and the recognized text to determine that a meeting for Nov. 2, 2012, should be scheduled in the calendar application on the second device. Consider, for example, that a calendar event will have context of title, date, reference words like subject and location, while a contact will have fields like name, company and e-mail addresses and phone numbers to indicate context.

In an another example, recognition module 280 may recognize text the “John Doe, Engineer, (123)456-7890, john.doe@xyz.xyz, 123 xyz Boulevard” from an image captured from the first device, and determine that the character strings “(123)456-7890” and “john.doe@xyz.xyz”, and phrases “John Doe”, “123 xyz Boulevard”, are context elements. The application on the second device can use the context elements and the recognized text to determine that a contact entry that includes the recognized text, should be created in the address book application on the second device.

Or, still further, consider context indicated by straight forward highlighting or outlining of text in regular formatting; this is considered the text that is selected for copying even though the copying won't happen directly in the first device. On touchscreen devices it is common for there to be handles at the start and end of the selection so you can adjust the selection. The system in the second device might recognize the style of highlighting or handles for the various common operating systems and popular applications but it should be able to recognize “generic” highlighting as well. There could be a disambiguation system that lets the user pick the right group of text if the system is recognizing multiple highlights and can't make a good guess on which the right one should be. Such might be the case on a badly formatted webpage, for example.

Referring now to FIG. 3, what is shown is an illustrative representation 300 of an example mobile communication device 202 of FIG. 2. Device 300 has at least display 304, which corresponds to display 222, and a keyboard 308, which corresponds to 232. Although shown enlarged in FIG. 3 for clarity, this mobile communication device 300 is sized to be a handheld portable device. Device 300 has a chassis or housing 306 that supports a display 304. Display 304 can have one or display elements such as such as an array of light emitting diodes (LED), liquid crystals, plasma cells, or organic light emitting diodes (OLED). Other types of light emitters are also contemplated. Housing 306 may also support a keyboard 308 either in the form of a separate keyboard or a virtual keyboard implemented in a touch sensitive display. Device 300 also has a speaker 305 for generating audio output, and a microphone 302 for receiving audio input

A wide range of one or more pointing or cursor/view positioning mechanisms such as a touch pad a joystick button, a mouse, a touchscreen, a tablet, or other whether presently known or unknown, may be employed. The cursor may be or include a pointer, a movable item or other visual cue used to mark a position or point to another item on a display, in order to, for example, indicate position for data entry or for selection of the other item.

The keys of keyboard 308 are disposed on a front face of a housing 306. Keyboard 308 is in the example form of a reduced QWERTY keyboard including a plurality of keys that serve as input members. Keyboard 308 may be of other configurations, such as an AZERTY keyboard, a QWERTZ keyboard, a Dvorak keyboard, or other keyboard or keypad arrangement, and either reduced or not reduced (i.e. full). In a “full” or non-reduced keyboard or keypad arrangement, each key has a single letter (not multiple letters) of the alphabet assigned to it.

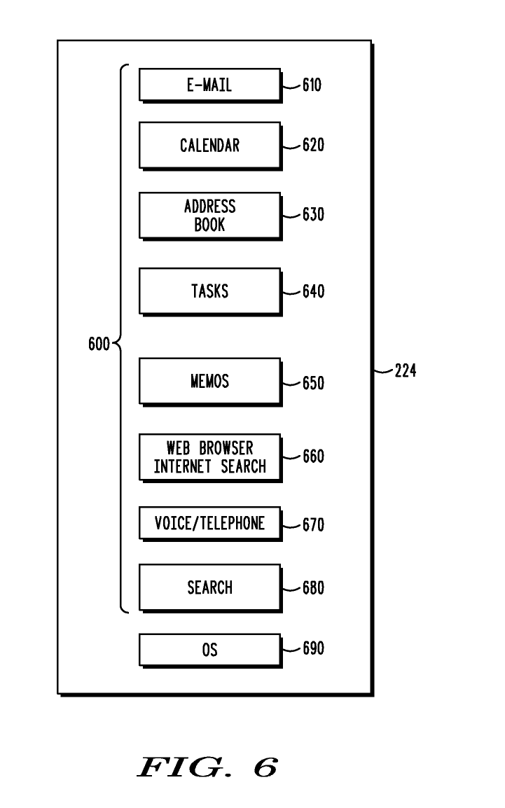

Among keys of keyboard 308 is a <RETURN> or <ENTER> key. The <RETURN> or <ENTER> key, for example, may be a symbol (such as an arrow) or may be the word “RETURN” or “ENTER” provided (e.g. printed) on the key, and may be pressed to provide a selection input to the processor. Display 304 may include a cursor that depicts generally where the next input or selection from the user interface will be received. Display 304 is shown in FIG. 3 as displaying a home screen that represents a number of applications 600 (FIG. 6) depicted as corresponding discrete icons 388. Icons 388 include, for example, a Voice/Telephone icon 384, an Electronic Mail (E-Mail) icon 390, a Calendar icon 392, an Address Book icon 394, a Tasks icon 396, a Web browser/search application icon 397, a MemoPad icon 398, and a Local Device Search icon 399, respectively.

In FIG. 3, the “home” screen output is shown as currently active and constitutes the main application for displaying the icons 388 shown. An application, such as E-mail application 610 or Calendar application 620 of FIG. 6, may then be initiated (opened or viewed) by providing a suitable user input to it. For example, Calendar application 620 may be initiated (opened or viewed) by controlling a positioning mechanism to cause the Calendar 392 to be highlighted and selected. As another example, display 222 displays icon 399 associated with Search application 680 and accepts similar inputs from the positioning mechanism to initiate a search from that icon 399. Applications 600 may be additionally or alternatively initiated (opened or viewed) by providing similar inputs through the positioning mechanism.

Although a generic mobile communication device 202 has just been described, any suitable mobile communication device or terminal may be part of the inventive methods and apparatus which will be described in fuller detail below. Note that many components of mobile device 202 shown and described may not be included (e.g. a full QWERTY keypad may be optional or may be implemented as a virtual keyboard).

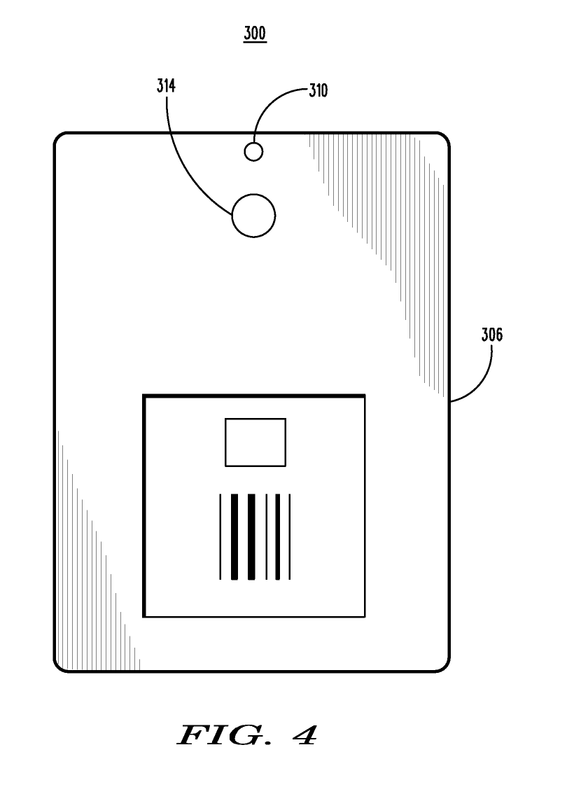

Referring to FIG. 4, an example rear view of device 300 is shown. In FIG. 4, device 300 is also shown as having an integral flash 310 and an optical capture unit (i.e., a digital camera) 314 that are used for flash or non-flash digital photography. (In other example embodiments, the integral flash 310 and an optical capture unit 314 are located at the front of device 300.) It is to be understood that the term “optical” as used in relation to optical capture unit 314 is intended to include an array of charge coupled devices (CCD) (or a functionally equivalent optical transducer structure) that is configured, in association with a lens structure, to receive an image in the form of electro-magnetic energy substantially within the visible spectrum, and to convert that energy into an electronic signal which can be further processed. The electronic signal is digitized for storage to a memory or storage device. The stored digitized image can be further processed and can be generated on display 304, and can be processed in the manner discussed in more detail below. Flash 310 can activate to provide additional lighting to assist the capture of energy by optical capture 314. In general, it is to be understood that optical capture unit 314 can, if desired, be implemented, or based on, a digital camera function as commonly incorporated into portable electronic devices such as cellular telephones.

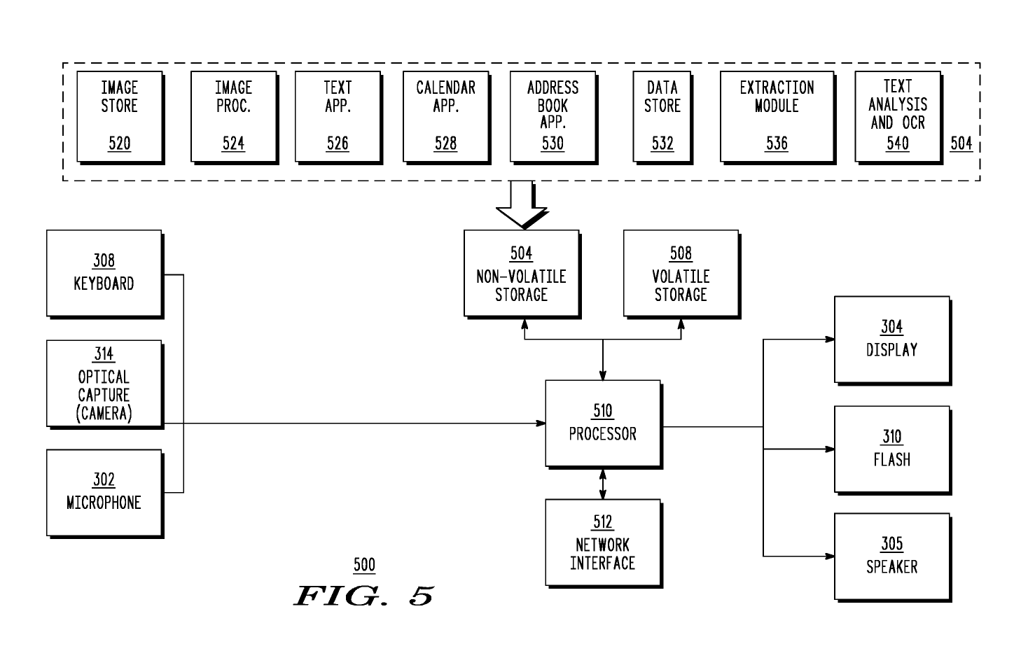

FIG. 5 shows an example of a schematic block diagram 500 of the electronic components of one example implementation of device 300. It should be emphasized that the structure in FIG. 5 is an example and not to be construed as limiting. Device 300 includes a plurality of input devices which in a present example embodiment includes keyboard 308 (which may correspond to keyboard 232 of FIG. 2), microphone 302 (which may correspond to microphone 236 of FIG. 2), in addition to optical capture unit (digital camera) 314 (which may correspond to image capture module 270 of FIG. 2). Other input devices are also contemplated. Input from keyboard 308, microphone 302 and optical capture unit 314 is received at a processor 510. Processor 510, which may include one or more processors, can be configured to execute different programming instructions that can be responsive to the input received via input devices. To fulfill its programming functions, processor 510 is also configured to communicate with a non-volatile storage unit 504 (e.g. Erase Electronic Programmable Read Only Memory (“EEPROM”), Flash Memory) and a volatile storage unit 508 (e.g. random access memory (“RAM”)). Programming instructions that implement the functional teachings of device 300 as described herein can be maintained, persistently, in non-volatile storage unit 504 and used by processor 510 which makes appropriate utilization of volatile storage 508 during the execution of such programming instructions.

Processor 510 in turn is also configured to display images on display 304, control speaker 305 including associated audio circuitry (not shown) and flash 310, also in accordance with different programming instructions and optionally responsive to inputs received from the input devices.

Processor 510 also connects to a network interface 512, which can be implemented in a present example embodiment as a radio configured to communicate over a wireless link (e.g., a cellular telephone link), although in variants device 300 can also include a network interface for communicating over a wired link. Network interface 512 can thus be generalized as a further input/output device that can be utilized by processor 510 to fulfill various programming instructions. It will be understood that interface 512 is configured to correspond with the network architecture that defines such a link. Present, commonly employed network architectures for such a link include, but are not limited to, Global System for Mobile communication (“GSM”), General Packet Relay Service (“GPRS”), Enhanced Data Rates for GSM Evolution (“EDGE”), 3G, High Speed Packet Access (“HSPA”), Code Division Multiple Access (“CDMA”), Evolution-Data Optimized (“EVDO”), Institute of Electrical and Electronic Engineers (IEEE) standard 802. 11, Bluetooth™ or any of their variants or successors. It is also contemplated each network interface 512 can include multiple radios to accommodate the different protocols that may be used to implement different types of links.

As will become apparent further below, device 300 can be implemented with different configurations than described, omitting certain input devices or including extra input devices, and likewise omitting certain output devices or including extra input devices. However, a common feature of any device 300 used to implement the teachings of this specification includes optical capture unit 314 and accompanying processing and storage structures.

Processor 510 is configured to execute image processing application 524 and executable application that may be able to use recognized text information, such as text application 526, calendar application 528, and address book application 530, making use of the image store 520 and data record store 532 as needed. Other types of executable applications may run on device 300 that may make use of recognized text, such as a mapping application, a media player application, a social networking application, in accordance with various examples of the invention, as will be further described. In one example embodiment, as will be explained further below, processor 510 is configured, using image processing application 524, to optically capture an image via optical capture unit 314, so that the image can be analyzed to recognize a context element associated with text of the image and performing optical character recognition on text with which the context element is associated to generate recognized text, using text analysis and optical character recognition (OCR) module 540 (which may correspond to recognition module 280 of FIG. 2). Following optical character recognition of the text by text analysis and OCR module 540, extraction module 536 extracts from the image the recognized text. Processor 510 is then configured to execution on device 300 and use the recognized text in accordance with the context of the text.

Non-limiting, example implementations of these general examples will be discussed in further detail below. Memory/storage device 504 can also contain other programs, apps, operating system, data, etc.

As shown further in FIG. 6, memory 224 of mobile communication device 202 includes a plurality of applications or routines 600 associated with the visually displayed icons 388 of FIG. 3 for the processing of data. Applications 400 may be in any of a variety of forms such as, without limitation, software, firmware, and the like. Applications 600 include, for example, an Electronic Mail (E-Mail) application 610 (FIG. 6) associated with E-mail icon 390 (FIG. 3), a Calendar application 620 (FIG. 6) associated with Calendar icon 392 (FIG. 3), an Address Book application 630 (FIG. 6) associated with Address Book icon 394 (FIG. 3), a Tasks application 640 (FIG. 6) associated with Tasks icon 396 (FIG. 3), a MemoPad (Memos) application 650 (FIG. 6) associated with MemoPad icon 398, a Web Browser or search application 660 (FIG. 6) associated with Web Browser/Search Application icon 397 (FIG. 3), a Voice/Telephone application 670 (FIG. 6) associated with Voice/Telephone icon 384, and a Local Device Search application 680 (FIG. 6) associated with Local Device Search icon 399 (FIG. 3). An operating system (OS) program 690 also resides in memory 224.

Generally, a communication device, such as a handheld, mobile device like a smart phone, a mobile telephone or a personal digital assistant PDA (personal digital assistant) enabled for wireless communication, or a computer system with a wireless modem, or wireless communication devices such as pagers, cellular phones, cellular smart-phones, wireless organizers, wirelessly enabled notebook computers, tablets, and the like, having an image capture module, such as a camera, can be used to capture both context and data from other devices and then make use of text recognized from the captured image in an application executing on the communication device in accordance with the context exhibited in the captured image. Thus, a person using a smartphone can capture context and data from applications running and being displayed on other devices, such as a personal computer (PC), a cellular phone, or a tablet. Moreover, context and data captured by an image capture module of a communication device may be displayed not by another mobile communication device, but may be captured from other displays capable of displaying both context and text, such as a TV display, a digital billboard, etc.

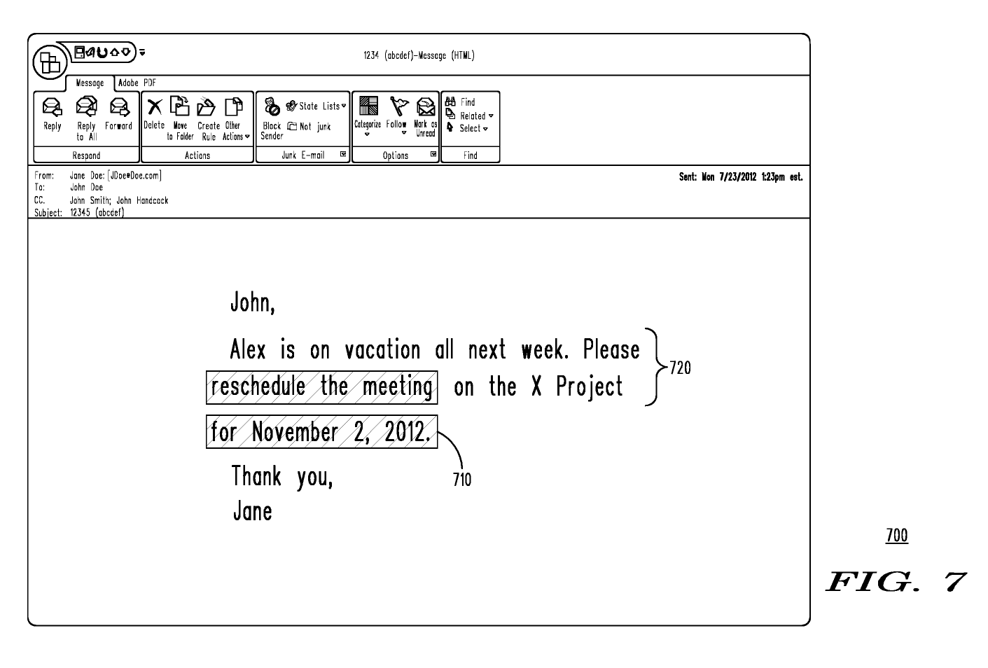

Referring now to FIG. 7, a display screen 700, in this example an email message application 730, is displayed on a display of a first device, such as 202 of FIG. 2, 300 of FIG. 3, a tablet, or the like, on which the email message application 730 is executing. A user of the first device can trigger a text selection mode and highlight a sentence of text as shown here. The same user or a different user can use the image capture module of the second device to take a picture, image or video of the display screen of the first device, on which the application is displayed. The image taken of display screen 700 by the second device, which may be a picture or video, is analyzed by recognition module 280 to recognize the context elements of context associated with the highlighted text. The recognition software of recognition module 280 may be able to recognize different patterns and elements associated with different applications and/or software platforms. For example, the selected text may be indicated by handles, shading, or other indicators of the selected text. In this particular example, the context element 710 present in the image that is recognized by the recognition module 280 is text selection of the text 720, indicated by the highlighted text.

Once the highlighted text is recognized by the recognition module 280, optical character recognition (OCR) is performed on the recognized text within the image by recognition module 280. Extraction module 280 can then extract the text. It is then available to be pasted in an application running on the second device in accordance with the context of the text, determined using the context element. Alternatively, it may be saved to a clipboard application on the second device, from which it may be later used by an application on the second device. The recognized, highlighted text is available to be used in a number of applications that make use of highlighted text that can be copied and pasted, including in an email message application, an address book application, a text application (such as a word processing application, for example), a calendar application (such as a calendar event to be added to a calendar application), a mapping or navigation application, a media player application (such as highlighted song or album details), and a social media application (such as a Twitter application or Facebook application that supplies context associated with text about someone to follow in that social media application), for instance.

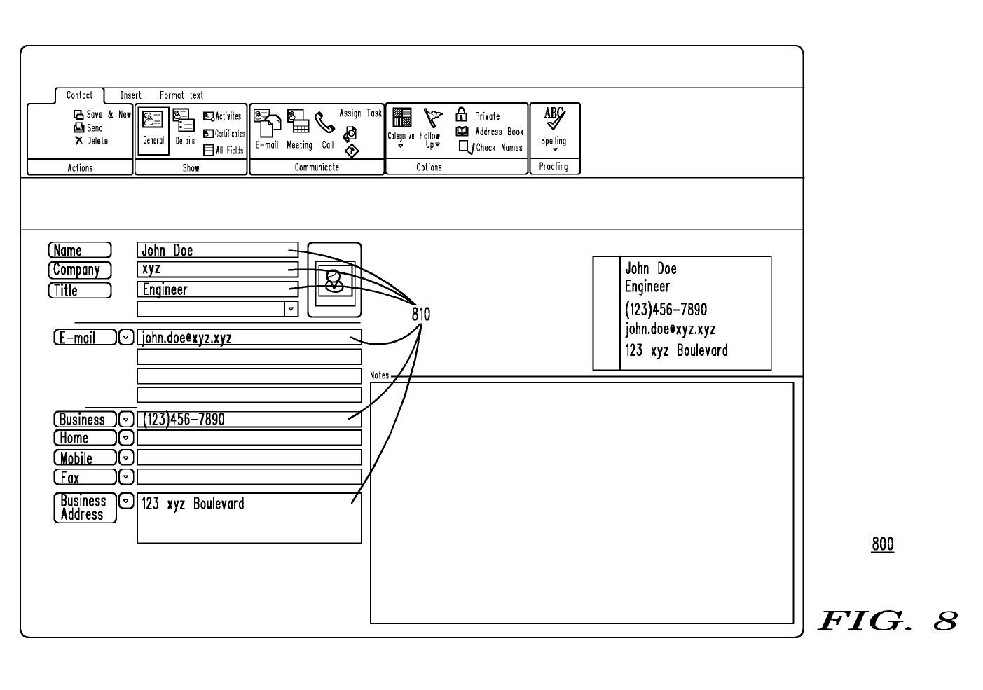

Consider another example using an address book application. Referring now to FIG. 8, a display screen 800 of a first device displays an address book application on a display or screen of the first device. There is certain contact card formatting 810 of the address book application that provides context elements indicating that text appearing within the contact record is associated with an address book application. Context elements of a address book application include, for example, the title bar of the application, labeled “Contact,” the contact tab at the top of the screen, the icons on the tool bar, and, of course, the data fields of the contact, such as Full Name, company, job title, e-mail, IM address, web page address, phone numbers (business, home, fax, mobile), and addresses, and their associated formatting.

A user of the first device or of the second device can take a picture of the contact card displayed on the first device using the optical capture module 314 of the second device of the displayed contact card, or may even take a video recording of a user of the first device scrolling through their whole list of contact cards, again using the image capture module 270 of the second device. The image taken of display screen 800 by the second device is analyzed by recognition module 280 to recognize the context elements associated with the text in the contact. The recognition software of recognition module 280 may be able to recognize different patterns and elements associated with different applications and/or software platforms. Recognition module 280 (such as text analysis and OCR module 540 of FIG. 5) of the second device can recognize these fields and formatting as context elements associated with an address book application and can then perform OCR on the recognized text, making it available to be extracted by extraction module 290. The recognized contact text can then be added to an address book application running on the second device if so desired, or it

Once the highlighted text is recognized by the recognition module 280, optical character recognition (OCR) is performed on the recognized text within the image by recognition module 280. Extraction module 280 can then extract the text from the image taken of the contact card displayed on the first device. It is then available to be pasted in an application running on the second device in accordance with the context of the text, determined using the context element. Alternatively, it may be saved to a clipboard application on the second device, from which it may be later used by an application on the second device. In this case, the context element associated with the text is the contact card formatting of the displayed contact card. The recognized text is available to be used in a number of applications that can make use of the recognized text, such as in an address book application running on the second device, or it can be copied and pasted in other applications, such as an email message application, a text application (such as a Word, for example), a calendar application (such as a calendar event to be added to a calendar application), a mapping or navigation application, a media player application (such as highlighted song or album details), and a social media application (such as a Twitter application or Facebook application that supplies context associated with text about someone to follow in that social media application), for instance.

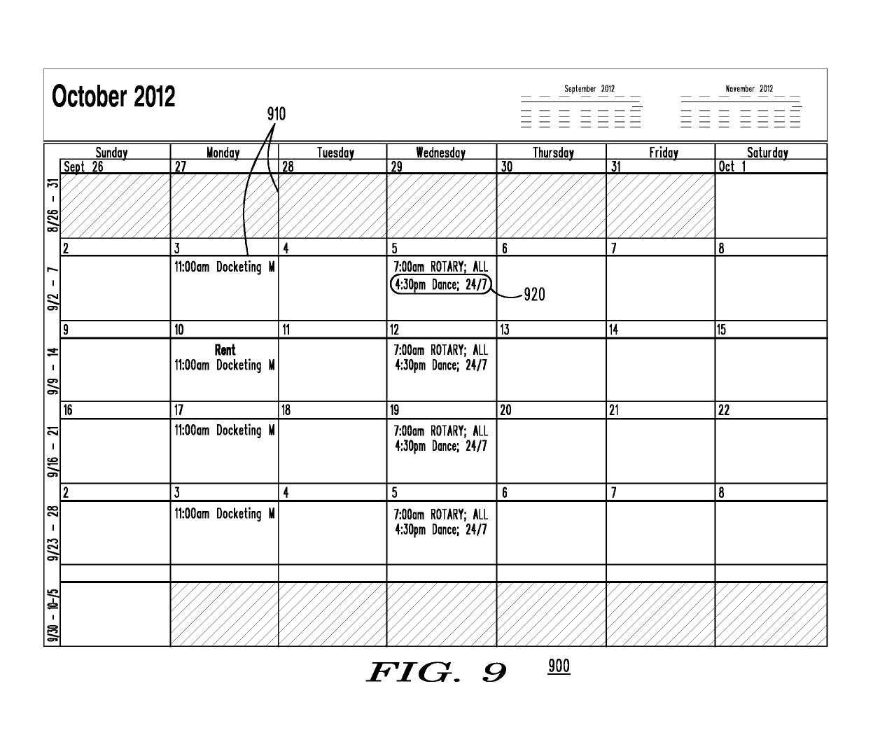

Referring now to FIG. 9, a calendar application 900 is displayed on a display or screen of a first device. The calendar application has calendar display layout features 910, such as the grid, that can be recognized by the recognition module 280 of the second device; as previously discussed, the second device also has an image capture module 270 and an extraction module 290. A user can use the image capture module of the second device to take a picture of the display screen of the first device on which the calendar is displayed. The image taken of display screen 900 by the second device is analyzed by recognition module 280 to recognize the context elements associated with the text. The recognition software of recognition module 280 may be able to recognize different display layouts, patterns and elements associated with different applications and/or software platforms. In this particular example, the context element 910 present in the image is the display layout associated with the calendar application 900; this context element 910 is associated with text, such as text 920, for example.

Once the highlighted text is recognized by the recognition module 280, optical character recognition (OCR) is performed on the recognized text within the image by recognition module 280. Extraction module 280 can then extract the text 920. It is then available to be pasted in an application running on the second device in accordance with the context of the text, determined using the context element (calendar application display layout). Alternatively, it may be saved to clipboard application on the second device, from which it may be later used by an application on the second device. In this case, the context is a calendar and the context element 910 associated with text 920 is calendar application display layout. The recognized text is available to be used in a number of applications that make use of the recognized text that can be copied and pasted, including in another calendar application executing on the second device, or on another type of application executing on the second device, such as an email message application, an address book application, a text application (such as a word processing application, for example), a mapping or navigation application, a media player application (such as highlighted song or album details), and a social media application (such as a Twitter application or Facebook application that supplies context associated with text about someone to follow in that social media application), for instance.

Consider yet another example of text having an associated, recognizable context element that may be displayed on a screen or display of a first device and captured by an image capture module of a second device, is a command. Such commands may be set off by a hash tag element or other context element. For example, the command >>call Jason might appear in many types of applications, such as a calendar application, a messaging application, or a social networking application. For each of these recognition of the hash tags as context elements of a command by the recognition module 180 and then OCR on the text (call Jason) associated with the hash tags, provides recognized text that may be extracted by extraction module 290. This command may then be pasted and used in applications running on the second device that can make use of commands. Again, these applications may be any number of applications, including but not limited to task reminder, calendar, messaging application, or social networking applications.

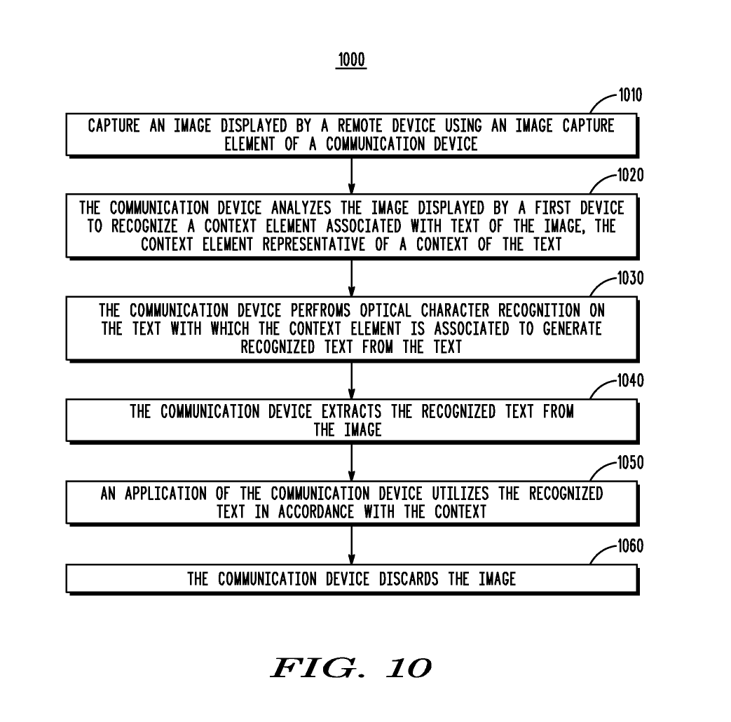

Turning now to FIG. 10, a flow chart 1000 depicts an implementation of an example embodiment consistent with the present disclosure. In this example, method 1000 provides for the extraction and use of text displayed by a first device by a second communication device 202, 300 based upon determined context of the text displayed by the first device. At 1010 an image displayed for the first device is captured by an image capture element 270 of a second communication device, having the image capture module 270, the recognition module 280 and the extraction module 290. This image capture is optional in the sense that it may not be required prior to the second device performing the analysis in 1020, and thus may or may not be performed before 1020. In certain example embodiments, the image capture element 270 may be a camera, such as a camera of a smartphone or a wireless cellular phone, for example. In addition to still images and photographs, the image may be a video.

At 1020, the communication device analyzes the image displayed by a first device to recognize a context element associated with text in the image, the context element representing a context of the text. At 1030, the communication device performs optical character recognition (OCR) on the text with which the context element is associated to generate recognized text from the text of the image. It is important to note that though the operations of 1020 and 1030 are shown in separate blocks, 1030 doesn't need to occur after 1020 but may also occur concurrently to 1020. At Block 1040, the communication device extracts the recognized text from the image. At 1050, an application of the communication device may utilize the recognized text in accordance with the context of the text.

As described above, after a selection of text at the first device, such as by highlighting or shading, or using a cut and paste feature of an application of the first device, the text may be recognized and utilized at the second communication device at 1050, by for example pasting the recognized text entry in the application running on the second communication device. Further, the second communication device that performs the analyzing performing and extracting may further paste the recognized text in a text entry in the application of the second communication device. Or, the text recognized at the first device may be a contact card data, with the context element being contact card formatting. In this case, utilizing the recognized text at 1050 may include adding the recognized text of the contact card to a contact list of an application, such as an address book application, running on the second device. Additionally, the recognized text of the contact card may be added in the address book application. Furthermore the context element may be a calendar application display layout, discussed above. Thus the application at the second device that utilizes the recognized text at 1050 may be a calendar program and the recognized text may be added to a calendar of the calendar program of the second device. Another example discussed above, is that the context may be a command with the context element being a hash tag element. Utilizing the recognized text at 1050 may include placing the recognized text of the command in either a calendar application or a task reminder application.

At 1060, optionally, the communication device may discard the captured image after the text has been recognized.

The order in which certain operations of FIG. 10 occur such as those represented by Blocks 1010, 1020 and 1030 is not critical, and these operations may occur in any order. Thus, while the blocks including the methods are shown as occurring in a particular order, it will be appreciated by those skilled in the art upon consideration of the present teachings that many of the blocks may be interchangeable and can occur in different orders than that shown without materially affecting the end results of the methods.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

It will be appreciated that any module or component disclosed herein that executes instructions may include or otherwise have access to non-transitory and tangible computer readable media such as storage media, computer storage media, or data storage devices (removable or non-removable) such as, for example, magnetic disks, optical disks, or tape data storage, where the term “non-transitory” is intended only to exclude propagating waves and signals and does not exclude volatile memory or memory that can be rewritten. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server, any component of or related to the network, backend, etc., or accessible or connectable thereto. Any application or module herein described may be implemented using computer readable/executable instructions that may be stored or otherwise held by such computer readable media.

The present disclosure may be embodied in other specific forms without departing from its spirit or essential characteristics. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A communication device, comprising:
an image capture element operable to capture an image displayed by a first device;
a processor, in communication with the image capture element, and configured to:
recognize text in the image;
recognize a context element in the image, the context element representing a context of the recognized text;
perform optical character recognition of the recognized text;
extract from the image the recognized text; and
use the recognized text in an application and in accordance with the context of the text.

2. The device of claim 1, wherein the image has a text entry portion that includes the text.

3. The device of claim 1, wherein text selection of the text is a cut and paste feature of an application executed on the first device.

4. The device of claim 1, wherein the application on the communication device is a text application that utilizes the recognized text by pasting the recognized text as a text entry in the application.

5. The device of claim 1, wherein the context element includes contact card formatting.

6. The device of claim 5, wherein the application on the communication device is an address book application that utilizes the recognized text by adding the recognized text of the contact card to a contact list.

7. The device of claim 1, wherein the context element includes calendar formatting.

8. The device of claim 7, wherein the application on the communication device is a calendar application that utilizes the recognized text by adding the recognized text to a calendar of the calendar program.

9. The device of claim 1, wherein the context element includes a command.

10. The device of claim 9, wherein the context element includes a hash tag element.

11. The device of claim 9, wherein the application on the communication device utilizes the recognized text by placing the recognized text as a reminder in one or more of a calendar and a task reminder.

12. The device of claim 1, wherein the image capture module is a camera.

13. The device of claim 1, wherein the image includes a video.

14. A processor implemented method, comprising:
capturing an image displayed by a first device;
recognizing a text in the image;
recognize a context element in the image, the context element representing a context of the recognized text;
using the recognized text in an application, and in accordance with the context.

15. The method of claim 14, wherein the image has a text entry portion that includes the text.

16. The method of claim 14, wherein text selection of the text is a cut and paste feature of an application of the first device that displayed the image.

17. The method of claim 14, where utilizing the recognized text includes pasting the recognized text entry in the application.

18. The method of claim 17, wherein the communication device that performs the analyzing, performing, and extracting further performs pasting the recognized text in a text entry in the application of the communication device.

19. The method of claim 14, wherein the context element includes contact card formatting.

20. The method of claim 19, wherein utilizing the recognized text includes adding the recognized text of the contact card to a contact list of the application.

21. The method of claim 20, wherein the application of the communication device is an address book application and the utilizing the recognized text further includes adding the recognized text of the contact card in the address book application.

22. The method of claim 14, wherein the context element includes calendar formatting.

23. The method of claim 22, wherein the application is a calendar program and utilizing the recognized text includes adding the recognized text to a calendar of the calendar program.

24. The method of claim 14, wherein the context element includes a command.

25. The method of claim 24, wherein the context element includes a hash tag element.

26. The method of claim 25, wherein utilizing the recognized text includes placing the recognized text of the command in one or more of a calendar application and a task reminder application.

27. The method of claim 14, further comprising:
capturing the image displayed by the first device using an image capture element of the communication device.

28. The method of claim 14, wherein the image capture element includes a camera.

29. The method of claim 14, further comprising after extracting the recognized text:
the communication device discarding the image.

30. The method of claim 14, wherein the image includes a video.
